(19) United States
(12) Patent Application Publication
(10) Pub. No.: US 2010/0161657 A1
(43) Pub. Date: Jun. 24, 2010

(54) METADATA SERVER AND METADATA MANAGEMENT METHOD

(75) Inventors: Myung Hoon CHA, Daejeon (KR); Hong Yeon KIM, Daejeon (KR); Ki Sung JIN, Iksan-si (KR); Young Kyun KIM, Daejeon (KR); Han NAMGOONG, Daejeon (KR)

Correspondence Address: AMPACC Law Group, 3500 188th Street S.W., Suite 103, Lynnwood, WA, 98037, US

(73) Assignee: Electronics and Telecommunications Research Institute, Daejeon (KR)

(21) Appl. No.: 12/504,621

(22) Filed: Jul. 16, 2009

(30) Foreign Application Priority Data
Dec. 18, 2008 (KR) 10-2008-0129631

(51) Int. Cl. G06F 17/30; G06F 11/16

(52) U.S. Cl. 707/770; 714/54; 707/E17.032; 707/E17.014; 707/E17.01; 714/E11.055

(57) ABSTRACT

Provided are a metadata server cluster and a metadata management method thereof, which distribute metadata for a file to a cluster including a plurality of metadata servers to replicate the metadata. The metadata server includes a directory hierarchy storage unit, a metadata storage unit, and a search unit. The directory hierarchy storage unit stores all directory hierarchies which are stored in the metadata server cluster. The metadata storage unit stores metadata for a data file. The search unit searches the directory hierarchies and the metadata.

### CROSS-REFERENCE TO RELATED APPLICATIONS

This application claims priority under 35 U.S.C. §119 to Korean Patent Application No. 10-2008-0129631, filed on Dec. 18, 2008, in the Korean Intellectual Property Office, the disclosure of which is incorporated herein by reference in its entirety.

### TECHNICAL FIELD

The following disclosure relates to a file storage system, and in particular, to a metadata server cluster and a metadata management method thereof, which distribute metadata for a file to a cluster including a plurality of metadata servers to replicate the metadata.

### BACKGROUND

A storage system, which provides a large amount of shared space by using a plurality of computers that are connected to one another over a network, is configured with a data server storing data and a metadata server storing metadata. Typically, since the amount of relevant metadata is far less than that of stored data, the storage system may be configured with a plurality of data servers and one metadata server. Such a storage system is called an asymmetric storage system.

In an asymmetric storage system, many data servers are required when the amount of data to store increases exponentially, and consequently, the amount of metadata also increases greatly. If one metadata server is used even in such an environment, a bottleneck may occur because metadata requests from all clients are directed to the one metadata server. Consequently, the performance of metadata operations is degraded. Moreover, when a failure occurs in the metadata server, the limitation of availability arises, in which all service is interrupted. Furthermore, if the number of metadata to store increases exponentially, long-term expandability issues arise.

U.S. Patent Publication No. 20060026219, filed on Jul. 27, 2005 by Orenstein et al. and published on Feb. 2, 2006, discloses a metadata management method necessary for distributing and storing data such as video that is not altered. According to the metadata management method, the attributes of metadata are applied to a hash function to classify the entire metadata into a plurality of subsets based on a hash value, and the classified subsets of the metadata are referred to as a region. The entire metadata are classified into a plurality of regions, and each classified region is enabled to separately maintain its copy. Also, the regions are distributed to a plurality of nodes for storage. However, since a hash function for determining a node to store metadata is used, it is accompanied by limitations of having to move a considerable amount of metadata whenever a change occurs in a cluster for metadata servers. Consequently, such a metadata management method is intended to be applied to systems for archiving data that will remain unchanged.

U.S. Patent Publication No. 20060123024, filed on Dec. 1, 2005 by Sathyanarayan et al. and published on Jun. 8, 2006, discloses a method for providing consistent metadata to a cluster for nodes using a cluster database management system. According to the method for providing consistent metadata, when a cluster for LDAP servers exists, the cluster database management system manages the metadata, and each of the LDAP servers caches a portion of metadata in its own heap memory. Accordingly, the LDAP servers are configured to respond to requests from clients by using the metadata cached in their heap memories. If a specific client accesses a specific LDAP server and changes the metadata cached in its heap memory, the changed contents of the metadata are reflected in the entire cluster through the use of a shared memory and a specific protocol. Because specific environmental conditions such as the cluster database management system and the shared memory are assumed to be present, however, it is difficult to apply to general environments lacking LDAP service. Also, slight data inconsistency may occur until changed content is reflected in all LDAP servers.

### SUMMARY

In one general aspect, a metadata server in a metadata server cluster including a plurality of metadata servers sharing a directory hierarchy includes: a directory hierarchy storage unit storing all directory hierarchies which are stored in the metadata server cluster; a metadata storage unit storing metadata for a data file; and a search unit searching the directory hierarchies and the metadata.

In another general aspect, a metadata management method in a metadata server cluster including a plurality of metadata servers includes: checking a metadata server storing metadata for a data file on which a client requests an inquiry; providing information of the checked metadata server to the client; searching, by the checked metadata server, the metadata for the requested data file in response to the inquiry request of the client; and providing the searched metadata to the client.

In another general aspect, a metadata management method in a metadata server cluster including a plurality of metadata servers includes: receiving a making request of a directory; selecting a metadata server to make the directory; making a directory in a metadata storage unit of the selected metadata server; and reflecting the directory making to update a directory hierarchy.

In another general aspect, a metadata management method in a metadata server cluster including a plurality of metadata servers includes: receiving a metadata file generation request from a client; checking a metadata server with a directory to which the data file will belong; notifying the client of information on the checked metadata server; and receiving, by the checked metadata server, the metadata file generation request from the client, and generating a metadata file in the metadata server in response to the generation request.

### BRIEF DESCRIPTION OF THE DRAWINGS

FIG. 1 is a block diagram of a storage system, to which a metadata server cluster is applied, according to an exemplary embodiment.

FIG. 2 is a block diagram of a metadata server according to an exemplary embodiment.

FIG. 3 is an exemplary diagram illustrating the configuration of the metadata server cluster according to an exemplary embodiment.

FIG. 4 is an exemplary diagram illustrating the detailed configuration of the metadata server cluster according to an exemplary embodiment.

FIG. 5 is an exemplary diagram for describing a process of making a new directory (/C) in the metadata server cluster according to an exemplary embodiment.

FIG. 6 is an exemplary diagram for describing a process of generating a new directory (/C/file6) in the metadata server cluster according to an exemplary embodiment.

FIG. 7 is a flowchart illustrating a process of making a directory in the metadata server cluster according to an exemplary embodiment.

FIG. 8 is a flowchart illustrating a process of generating a file to record metadata in the metadata server cluster according to an exemplary embodiment.

FIG. 9 is a flowchart illustrating a process of inquiring the metadata of a specific file in the metadata server cluster according to an exemplary embodiment.

### DETAILED DESCRIPTION OF EMBODIMENTS

Hereinafter, exemplary embodiments will be described in detail with reference to the accompanying drawings. Throughout the drawings and the detailed description, unless otherwise described, the same drawing reference numerals will be understood to refer to the same elements, features, and structures. The relative size and depiction of these elements may be exaggerated for clarity, illustration, and convenience. The following detailed description is provided to assist the reader in gaining a comprehensive understanding of the methods, apparatuses, and/or systems described herein. Accordingly, various changes, modifications, and equivalents of the methods, apparatuses, and/of systems described herein will be suggested to those of ordinary skill in the art. Also, descriptions of well-known functions and constructions may be omitted for increased clarity and conciseness.

Metadata server directory hierarchy according to an exemplary embodiment is shared, and the contents of each directory are distributed to and stored in metadata servers by directory unit. A directory hierarchy master metadata server exists for a directory change operation, and a directory inquiry and an input/output operation on a file may be distributed to all the metadata servers. Accordingly, a metadata server according to an exemplary embodiment enhances the performance of a metadata operation, and also secure availability by maintaining the copy of metadata.

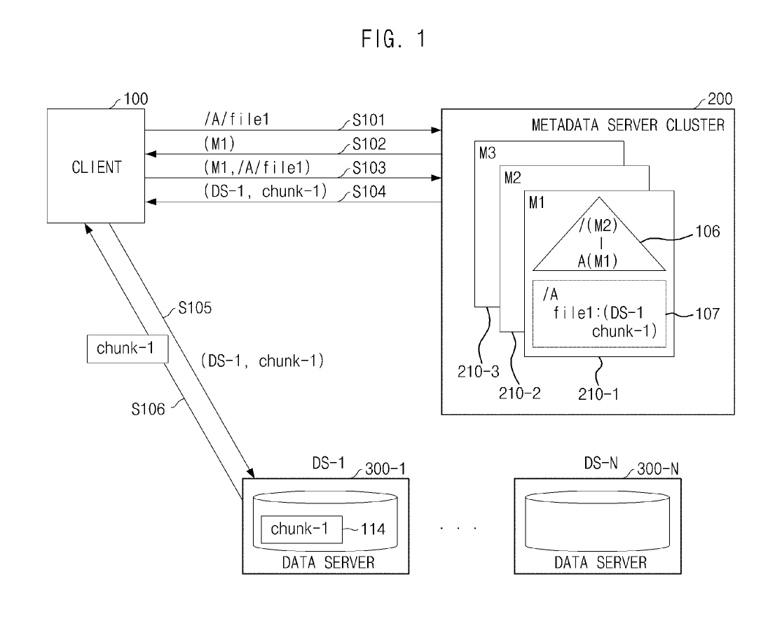

FIG. 1 is a block diagram of a storage system, to which a metadata server cluster is applied, according to an exemplary embodiment.

In this specification, the term “metadata server cluster” denotes the set of a plurality of metadata servers sharing a directory hierarchy. Moreover, the directory hierarchy means information that represents which metadata server a directory including each file is stored in.

Referring to FIG. 1, a storage system (to which a metadata server cluster is applied) according to an exemplary embodiment includes a client 100, a metadata server cluster 200, and a plurality of data servers 300-1 to 300-N (N is a natural number equal to or more than 2). Herein, the metadata server cluster 200 includes a plurality of metadata servers 210-1 to 210-3. For convenience and concentration, although only one client is shown, very many clients and data servers may be naturally disposed.

The following description will be made in detail with reference to FIG. 1 on the configuration of the storage system according to an exemplary embodiment.

A data 114 is stored in the data server (DS-1) 300-1 among the data servers 300-1 to 300-N, a metadata 107 linked to the data 114 is stored in the metadata sever (M1) 210-1. That is, metadata for a file are disposed in a directory including the file in a corresponding metadata server. A directory hierarchy 106, which is information that represents which metadata server a directory including each file is stored in, is shared by all the metadata servers of the metadata server cluster 200.

With reference to FIG. 1, a process will be described where the client 100 inquires the contents 107 of metadata for a file (/A/file1) to find from the metadata server of the metadata server cluster 200 and acquires an actual data 114 from the data server 300-1.

When the client 100 intends to inquire the contents of the file of a directory (/A), it queries to one metadata server that is selected at random from the metadata servers 210-1 to 210-3 of the metadata server cluster 200 in order to find a metadata server (M1) 210-1 where the metadata 107 of the file (/A/file1) is stored in operation S101.

Since all the metadata servers 210-1 to 210-3 store the same directory hierarchy 106, all the metadata servers of the metadata server cluster 200 check that the contents of the directory (/A) are in the metadata server (M1) 210-1, and notifies the check result to the client 100 in operation S102.

The client 100 requests the contents of the metadata to the metadata server (M1) 210-1 in operation S103, and the metadata server (M1) 210-1 notifies the client 100 of the fact that an actual data corresponding to the file (/A/file1) is stored as a chunk-1 114 in the data server 300-1 in operation S104. Accordingly, the client 100 accesses the data server 300-1 in operation S105, and acquires data in operation S106.

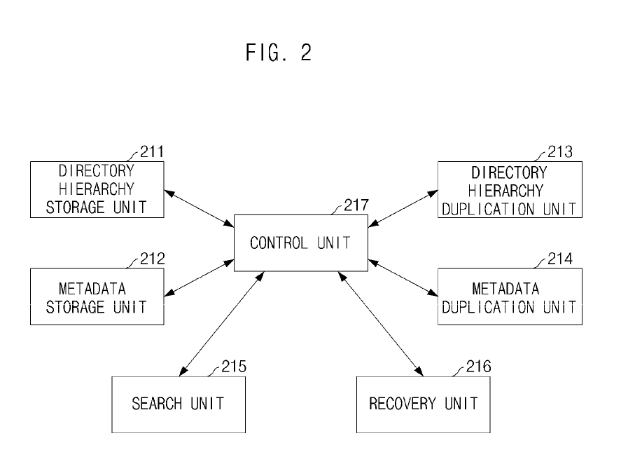

FIG. 2 is a block diagram of a metadata server according to an exemplary embodiment.

Referring to FIG. 2, the respective metadata servers 210-1 to 210-3 according to an exemplary embodiment includes a directory hierarchy storage unit 211, a metadata storage unit 212, a directory hierarchy duplication unit 213, a metadata duplication unit 214, a search unit 215, a recovery unit 216, and a control unit 217.

The directory hierarchy storage unit 211 stores at least one directory hierarchy. For example, a reference number “106” in FIG. 1 represents a directory hierarchy. As described above, the directory hierarchy includes information where the metadata of the files of the directory (/A) are stored in the metadata server (M1) 210-1, and is represented as “A(M1)” in FIG. 1.

In an embodiment illustrated in FIG. 1, since the files of the directory (/A) are stored in the metadata server (M1) 210-1, when intending to acquire the metadata of the file (/A/file1), the metadata of the file (file1) are checked in a case where a query is made to the metadata server (M1) 210-1 among the metadata servers 210-1 to 210-3.

Herein, the metadata of the file (file1) is to represent position information about which of the data servers 300-1 to 300-N data are stored in and information about all the attributes of the file (file1), for example, the size of the file and the access authority of the file. Such contents are recorded as one file.

The metadata storage unit 212 stores the metadata. In FIG. 1, a reference number “107” corresponds to the metadata storage unit 212.

The directory hierarchy duplication unit 213 replicates a directory hierarchy from one metadata server to another metadata server, and relevant description will be made below.

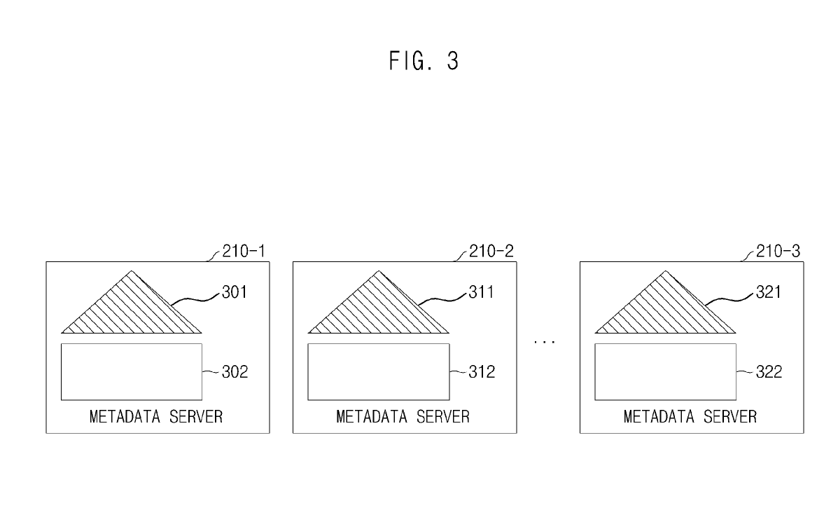

A metadata server according to an exemplary embodiment, as illustrated in FIG. 3, clusters with other metadata servers sharing a directory hierarchy to constitute a cluster.

That is, all the metadata servers 210-1 to 210-3 of the metadata server cluster 200 share the same directory hierarchy. For example, as illustrated in FIG. 3, 25 directory hierarchies 301, 311 and 321 have the same contents. Accordingly, even though the client 100 accesses any one of the metadata servers 210-1 to 210-3, it discovers the position of a metadata server storing metadata to find. In such a method, the directory hierarchy duplication unit 213 is included in a metadata server in order to make a directory hierarchy shared in the metadata server cluster 200.

In an exemplary embodiment, the duplication of a directory hierarchy is made from the specific metadata server (i.e., a directory hierarchy master metadata server storing the master copy of the directory hierarchy) to another metadata server in the metadata server cluster 200. In this case, the directory hierarchy master metadata server includes the directory hierarchy duplication unit 213 to replicate the directory hierarchy to other metadata servers. Accordingly, metadata operations such as directory making (mkdir) and directory removal (rmdir) are transferred only to the directory hierarchy master metadata server in the metadata server cluster 200.

In another exemplary embodiment, the arbitrary metadata server of the cluster 200 may be configured to replicate a directory hierarchy to other metadata server. In this case, the directory hierarchy duplication unit 213 is included in the each metadata server.

The selection of configuration is easily made according to the size and operation characteristics of the cluster 200.

In the following description on directory making and file generation, it is assumed that a specific metadata server serves as the directory hierarchy master metadata server. However, even when exemplary embodiments are configured for an arbitrary metadata server to change and replicate a directory hierarchy without a specific master metadata server in the cluster 200, it is apparent that one skilled in the art easily embody exemplary embodiments through changes and modifications within their spirit and scope from the following description.

Even though all the metadata servers of the cluster 200 share the directory hierarchy according to an exemplary embodiment, since the number of directories among information to be stored in the metadata server cluster 200 is relatively far less than that of data, there is little probability that the share of the directory hierarchy causes the increase of the load in a system level.

The metadata duplication unit 214 duplicates a directory, which is stored in a specific metadata server, in another metadata server for enhancing the availability of the metadata.

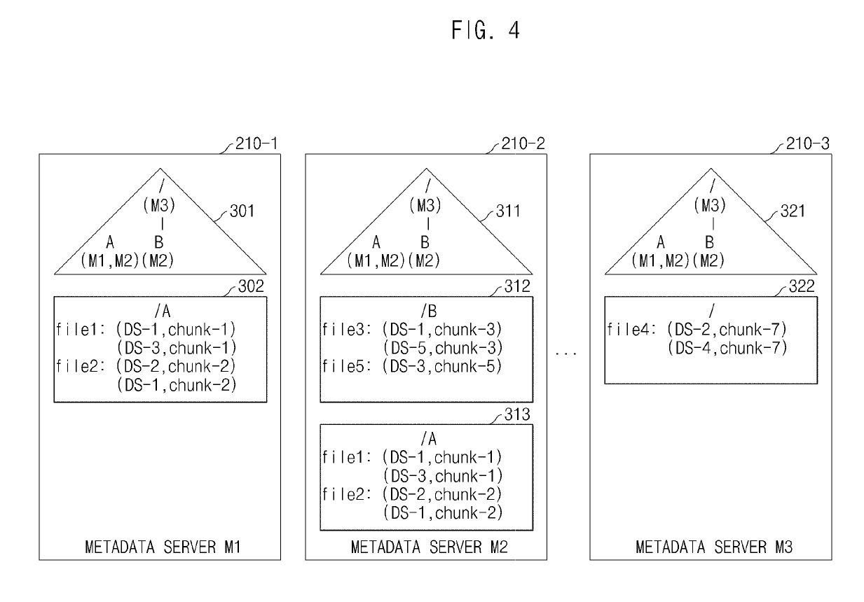

For example, the directory hierarchies 301, 311 and 321 in FIG. 4 are represented as “A(M1, M2)” to the directory (/A). This means that the files of the directory (/A) are stored in the metadata servers (M1 and M2) 210-1 and 210-2, the metadata of the files of the directory (/A) stored in the metadata server 210-1 are a master copy, and the metadata of the files of the directory (/A) stored in the metadata server 210-2 are a copy.

In FIG. 4, the metadata of the files (file1 and file2) of the directory (/A) are stored as the master copy in the metadata storage unit 302 of the metadata server 210-1, and are stored as the copy in the metadata storage unit 313 of the metadata server 210-2. Herein, the metadata storage units 302 and 313 and metadata storage units 312 and 322 are the same as those of the metadata storage unit 212 in FIG. 2.

In the duplication of the metadata, the cluster 200 selects metadata for duplicating and one or more metadata servers for storing a copy to duplicate the selected metadata in the selected one or more metadata servers, and thereafter reflects information (about which metadata server the master copy and copy of the metadata are stored in) in a directory hierarchy like the directory hierarchies 301, 311 and 321 in FIG. 4. Afterwards, all the metadata severs of the cluster 200 share the reflected directory hierarchy.

Such a process is performed in the metadata duplication unit 214, and it is apparent that an exemplary embodiment may have a configuration where an arbitrary metadata server in the cluster 200 leads the process or the directory hierarchy master metadata server leads the process.

In this way, the same metadata may be duplicated in the plurality of metadata servers. In this case, the number of metadata to duplicate may be adjusted in the setting of environment.

The number of the metadata to duplicate may be designated as “0”, but the number of the metadata to duplicate is designated as “1” for securing availability.

The search unit 215 inquires the directory hierarchy storage unit 211 to search a metadata server where a queried directory is disposed, and inquires the metadata storage unit 212 to search queried metadata that are stored in a metadata server.

The recovery unit 216 recognizes a metadata server where a failure occurs among the metadata servers 210-1 to 210-3 constituting the metadata server cluster 200, and increases the duplication number of the metadata which is stored in the recognized metadata server, thereby enabling a metadata service to be provided only to a plurality of the remaining metadata servers without interruption.

For example, if total four metadata servers exist and the same metadata are stored in two metadata servers among the four metadata servers, the stored duplication number of the metadata is “2”. When a failure occurs in one metadata server among the two metadata servers, the client 100 receives corresponding metadata from the remaining one metadata server, and thus, by additionally copying the available metadata of the remaining one metadata server in other metadata servers, the client 100 increases the duplication number of the metadata to prepare against the additional occurrence of a failure. The recovery unit 216 may be configured to autonomously have the duplication function of the metadata or to allow the metadata duplication unit 214 to perform duplication through notification. The control unit 217 overall controls the functions of the elements of the metadata servers 210-1 to 210-3.

The metadata duplication unit 214 and the recovery unit 216 may be disposed only in the specific metadata server (for example, the directory hierarchy master metadata server) of the cluster 200, and may also be disposed in all the metadata servers or some metadata servers in the cluster 200.

The following description will be made in detail on processes about the making of a directory, the generation of a file and the inquiry of the metadata of the file.

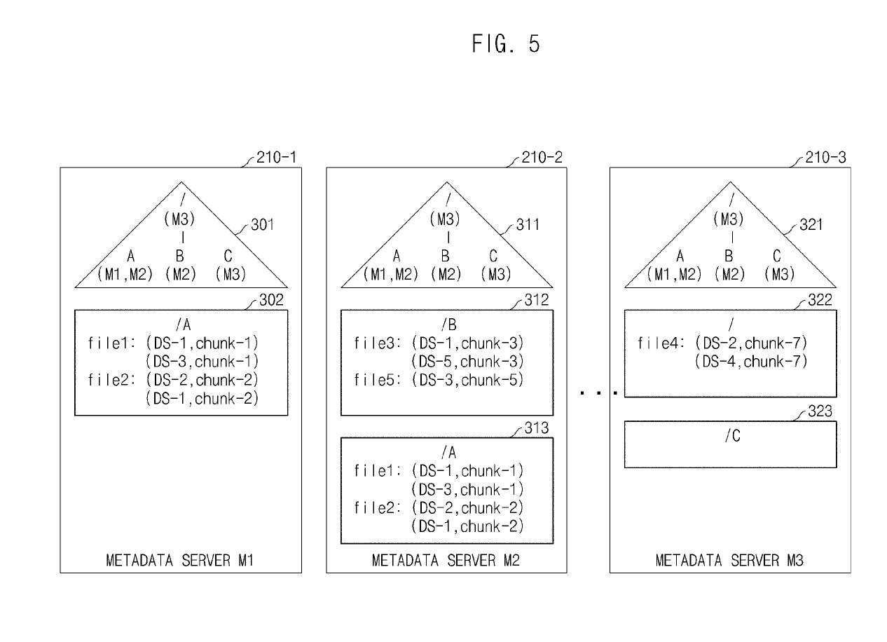

FIG. 5 is an exemplary diagram for describing a process of making a new directory (/C) in the metadata server cluster according to an exemplary embodiment.

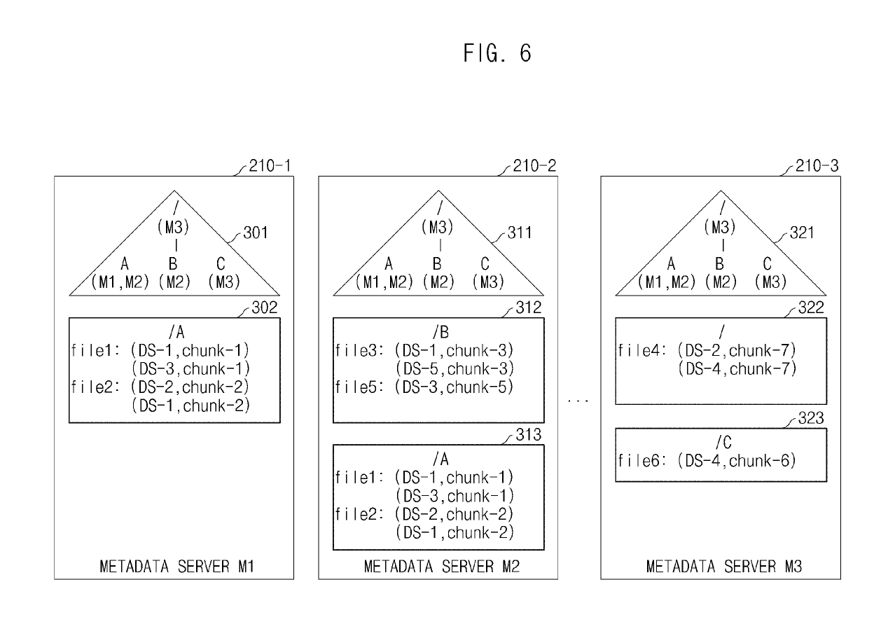

FIG. 6 is an exemplary diagram for describing a process of generating a new directory (/C/file6) in the metadata server cluster according to an exemplary embodiment.

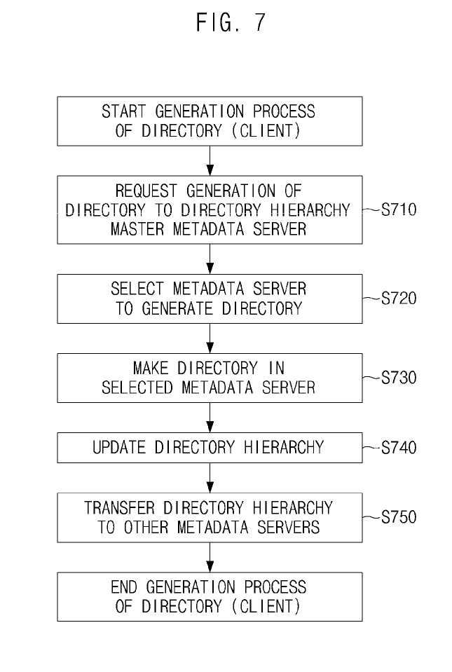

FIG. 7 is a flowchart illustrating a process of making a directory in the metadata server cluster according to an exemplary embodiment.

Hereinafter, a process of making a directory (/C) will be described with reference to FIGS. 5 and 7. Herein, as illustrated in FIG. 4, it is assumed that the directory (/C) does not exist in all the metadata servers of the cluster 200.

The client 100 transfers the making request of the directory (/C) to the directory hierarchy master metadata server (M1) 210-1 among the metadata servers (M1, M2 and M3) 210-1 to 210-3 of the metadata server cluster 200 in operation S710.

The directory hierarchy master metadata server (M1) 210-1 selects a metadata server to store the new directory (/C) from the metadata servers 210-1 to 210-3 in operation S720.

When the metadata server (M3) 210-3 is selected, as illustrated in FIG. 5, the directory hierarchy master metadata server (M1) 210-1 makes the directory (/C) 323 in the metadata server (M3) 210-3 in operation S730.

Subsequently, the directory hierarchy master metadata server (M1) 210-1 adds information C(M3) in its own directory hierarchy to update the directory hierarchy in operation S740. Afterwards, the directory hierarchy master metadata server (M1) 210-1 replicates information on the updated directory hierarchy 301 of FIG. 5 to other metadata servers to accord the contents of the directory hierarchies 301, 311 and 321 of all the metadata servers in the cluster 200 in operation S750.

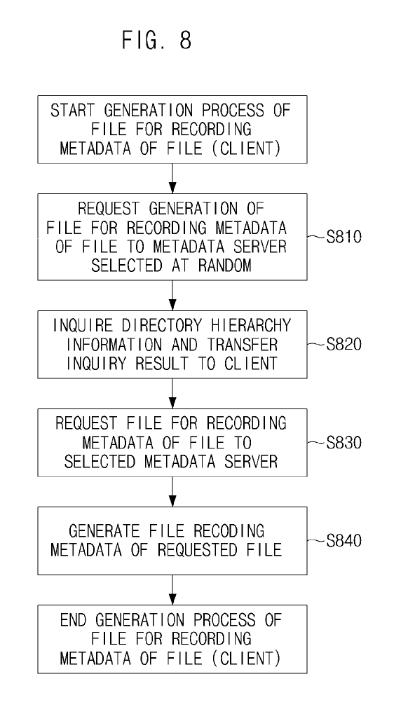

A file generation process is classified into an operation of generating a file to record metadata for a corresponding file in a metadata server and an operation of generating a file to store actual data in a data server. The following description will be made with reference to FIG. 8 on a process for generating a file to record the metadata of the file in the metadata server.

FIG. 8 is a flowchart illustrating a process of generating a file to record metadata in the metadata server cluster according to an exemplary embodiment.

Referring to FIGS. 5, 6 and 8, the client 100 selects a metadata server at random from among the metadata servers 210-1 to 210-3 of the metadata server cluster 200 and transfers the generation request of a file (/C/file6) to the selected metadata server in operation S810.

When the metadata server (M2) 210-2 receives the generation request of the file (/C/file6), the metadata server (M2) 210-2 inquires its own directory hierarchy 311, checks the information C(M3), i.e., the fact that the metadata server (M3) 210-3 stores the directory (/C), and notifies the client 100 to request the generation of the file (/C/file6) to the metadata server 210-3 in operation S820.

At this point, the client 100 transfers the generation request of the file (/C/file6) to the metadata server (M3) 210-3 in operation S830.

Accordingly, as illustrated in FIG. 6, the metadata server (M3) 210-3 generates metadata for a file (file6) in the metadata storage unit 323 in operation S840. Herein, the metadata storage unit 323 is the same as the metadata storage unit 212 in FIG. 2.

As a result, metadata for the file (/C/file6) are stored in the metadata server (M3) 210-3, the actual data of the file (/C/file6) are stored as a file type named a chunck-6 in a data server (DS-4) 300-4. For convenience and concentration, a process of selecting a data server to store the actual data of the file (/C/file6) and a process of dividing the actual data into a plurality of chunks to duplicate and store the divided chunks will be omitted.

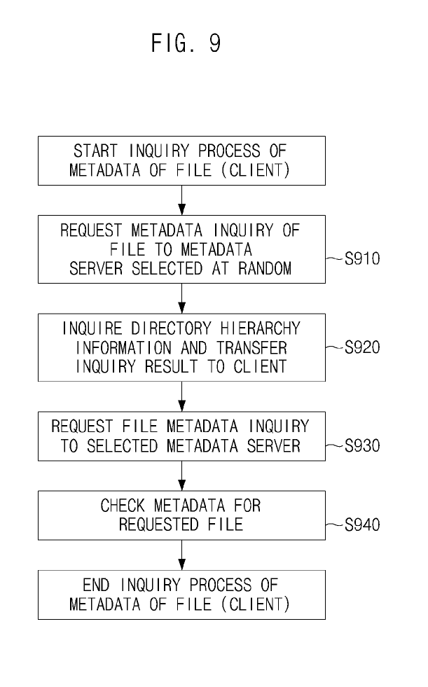

FIG. 9 is a flowchart illustrating a process of inquiring the metadata of a specific file in the metadata server cluster according to an exemplary embodiment.

Referring to FIGS. 6 and 9, the client 100 selects a metadata server at random from among the metadata servers 210-1 to 210-3 of the metadata server cluster 200 and transfers the inquiry request of metadata for a file (/B/file5) to the selected metadata server in operation S910.

When the metadata server (M3) 210-3 receives the inquiry request of the metadata for the file (/B/file5), the metadata server (M3) 210-3 inquires its own directory hierarchy 321, and thereafter checks information B(M2) in operation S920.

That is, the metadata server (M3) 210-3 checks the fact that a directory /B is stored in the metadata server 210-2, and commands the client 100 to request the inquiry of the metadata for the file (/B/file5) to the metadata server 210-2.

At this point, the client 100 transfers the inquiry request of the metadata for the file (/B/file5) to the metadata server 210-2 in operation S930.

Accordingly, by checking the metadata of the file (/B/file5) in the metadata storage unit 312, the metadata server 210-2 notifies the client 100 of the fact that the actual data of the file (/B/file5) are stored in a data server (DS-3) 300-3 in operation S940.

A new metadata server may be added in the metadata server cluster 200. In this case, information on the new metadata server is registered in the metadata server cluster, and a directory hierarchy stored in the existing metadata server of the metadata server cluster 200 is duplicated in the new metadata server, thereby adding the new metadata server in the cluster 200.

Registering information on the new metadata server in the cluster 200 may be performed through a process where the directory hierarchy master metadata server or the arbitrary metadata server of the cluster 200 adds the information (for example, identifier and nickname) of a metadata server that is added in the directory hierarchy.

Subsequently, the directory hierarchy where the added metadata server information is reflected is replicated to all other metadata servers in the cluster 200, and thus, all the existing metadata servers can recognize the existence of the added metadata server.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A metadata server in a metadata server cluster including a plurality of metadata servers sharing a directory hierarchy, the metadata server comprising:
a directory hierarchy storage unit storing all directory hierarchies which are stored in the metadata server cluster;
a metadata storage unit storing metadata for a data file; and
a search unit searching the directory hierarchies and the metadata.

2. The metadata server of claim 1, further comprising a directory hierarchy duplication unit duplicating the directory hierarchy to other metadata server of the metadata server cluster.

3. The metadata server of claim 1, further comprising:
a metadata duplication unit duplicating a content of the metadata storage unit to at least one other metadata server of the metadata server cluster; and
a recovery unit detecting a failure of the metadata server to recover the detected failure.

4. The metadata server of claim 3, wherein when a failure of a metadata server where metadata are duplicated is detected, the recovery unit duplicates the metadata in a new metadata server.

5. The metadata server of claim 1, wherein the metadata storage unit stores metadata for a plurality of data files of some directories among a plurality of directories which are stored in the metadata server cluster.

6. The metadata server of claim 1, wherein the search unit checks a metadata server storing metadata for a queried data file through the directory hierarchy storage unit in response to a data file inquiry query, and searches a requested metadata through the metadata storage unit in response to a metadata request.

7. A metadata management method in a metadata server cluster including a plurality of metadata servers, the metadata management method comprising:
checking a metadata server storing metadata for a data file on which a client requests an inquiry;
providing information of the checked metadata server to the client;
searching, by the checked metadata server, the metadata for the requested data file in response to the inquiry request of the client; and
providing the searched metadata to the client.

8. The metadata management method of claim 7, wherein the checking of a metadata server comprises:
receiving, by an arbitrary metadata server in the metadata server cluster, a data file inquiry request from the client;
searching, by a metadata server receiving the inquiry request, a directory hierarchy stored in the metadata server to check a directory comprising the data file; and
checking a metadata server storing metadata for a plurality of files of the checked directory.

9. The metadata management method of claim 8, wherein the arbitrary metadata server is selected at random by the client.

10. The metadata management method of claim 7, wherein the searching of the metadata comprises:
checking, by the checked metadata server, a directory comprising a data file inquired by the client among a plurality of directories which are stored in the checked metadata server; and
searching metadata for the data file in the checked directory.

11. The metadata management method of claim 7, further comprising duplicating the same metadata in other metadata server of the metadata server cluster.

12. The metadata management method of claim 11, wherein the duplicating of the same metadata comprises:
selecting metadata to duplicate;
selecting one or more metadata servers to store a copy of the metadata;
duplicating the selected metadata in the one or more metadata servers; and
reflecting the duplicated content in the directory hierarchy.

13. The metadata management method of claim 7, further comprising detecting a failure of the metadata server to recover the detected failure.

14. The metadata management method of claim 13, wherein the recovering of the detected failure comprises:
recognizing a metadata server where a failure occurs, among a plurality of metadata servers;
checking metadata which are stored in the metadata server having the failure;
recognizing a specific metadata server storing the same copy as the checked metadata; and
duplicating the copy in other metadata server.

15. The metadata management method of claim 7, further comprising adding a new metadata server in the metadata server cluster.

16. The metadata management method of claim 15, wherein the adding of a new metadata server comprises:
registering information of the new metadata server in the metadata server cluster; and
duplicating a directory hierarchy, which is stored in an existing metadata server of the metadata server cluster, in the new metadata server.

17. A metadata management method in a metadata server cluster including a plurality of metadata servers, the metadata management method comprising:
receiving a making request of a directory;
selecting a metadata sever to make the directory;
making a directory in a metadata storage unit of the selected metadata server; and
reflecting the directory making to update a directory hierarchy.

18. The metadata management method of claim 17, wherein the updating of a directory hierarchy comprises:
updating, by one metadata server comprised in the metadata server cluster, a directory hierarchy of the metadata server; and
duplicating the updated directory hierarchy to other metadata servers of the metadata server cluster.

19. A metadata management method in a metadata server cluster including a plurality of metadata servers, the metadata management method comprising:
receiving a metadata file generation request from a client;
checking a metadata server with a directory to which the data file will belong;
notifying the client of information on the checked metadata server; and
receiving, by the checked metadata server, the metadata file generation request from the client, and generating a metadata file in the metadata server in response to the generation request.

20. The metadata management method of claim 19, wherein the checking of a metadata server is performed by an arbitrary metadata server of the metadata server cluster which is selected at random by the client.
